(19) United States
(12) Patent Application Publication
(10) Pub. No.: US 2008/0059666 A1
(43) Pub. Date: Mar. 6, 2008

(54) MICROCONTROLLER AND DEBUGGING METHOD

(75) Inventor: Kazuya YAMADA, Miyazaki (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 11/764,949

(22) Filed: Jun. 19, 2007

(30) Foreign Application Priority Data
Aug. 30, 2006 (JP) 2006-234296

(51) Int. Cl. G06F 13/42

(52) U.S. Cl. 710/106

(57) ABSTRACT

A microcontroller has a RAM monitor function that facilitates debugging by enabling a debugging device to specify a location and access the specified location during program execution. Access takes place when the microcontroller's central processing unit or a peripheral module in the microcontroller satisfies a predetermined condition. The access can therefore be synchronized with the execution of a particular instruction, or the occurrence of an interrupt.

### BACKGROUND OF THE INVENTION

1. Field of the Invention

The present invention relates to a microcontroller with on-chip debugging features.

2. Description of the Related Art

Microcontrollers are used in a vast range of consumer and industrial products. A typical microcontroller is a semiconductor chip including both a central processing unit (CPU) and peripheral modules, as well as a read-only memory (ROM) storing program code and permanent data and a random-access memory (RAM) for temporary data storage. All of these facilities are interconnected by a system bus. By executing the program code, the CPU controls the peripheral modules, processes data, and communicates with or controls external devices.

Some recent microcontrollers have an on-chip RAM monitor function to aid in the debugging of the program code or the circuit in which the microcontroller is installed, by enabling a debugging device to read the microcontroller's RAM data and the contents of registers in its peripheral modules. The RAM monitor function is implemented by a data transceiver that transfers data between the microcontroller and the debugging device, and an access controller interposed between the data transceiver and the system bus that operates as a direct memory access controller, capable of accessing the RAM and the peripheral module registers independently of the CPU. The data transceiver and access controller are built into the microcontroller.

A conventional access controller operates according to address information received from the debugging device and a bus enable signal received from the CPU. The address information specifies an address or a range of addresses that the access controller wants to monitor. If the bus enable signal indicates that the bus is currently available, the access controller immediately reads data from the supplied address or address range and sends the data to the debugging device. If the bus enable signal indicates that the bus is in use by the CPU or a peripheral module, the access controller waits for the bus to become available, and then transfers the data to the debugging device.

A problem with this conventional access controller is that the debugging device cannot easily control the timing at which the RAM or register is actually accessed, since this timing depends only on the time at which the debugging device sets information in the access controller and on the bus enable signal output by the CPU. In many debugging situations it would be desirable to know what data are stored at a particular address when the CPU is executing a particular part of its program or when a particular event occurs, but the address setting timing and bus enable signal do not provide this type of access timing control.

U.S. Pat. No. 7,020,813 to Fujiuchi discloses a microcontroller with an on-chip RAM monitor function in which the access controller includes a control flag that can be set by instructions in the program. The access controller operates only when the flag is set. This enables the RAM monitor timing to be synchronized with program execution, but the need to embed extra instructions in the program is sometimes inconvenient.

### SUMMARY OF THE INVENTION

A general object of the present invention is to facilitate the debugging of a microcontroller.

A more particular object is to synchronize RAM monitoring with a specific event.

The invention provides a microcontroller having a CPU, a memory, and at least one peripheral module interconnected by a system bus. The microcontroller also has a data transceiver and an access controller.

The data transceiver receives monitor address information from an external device. The monitor address information designates a location in the memory or a location in the peripheral module.

The access controller is interposed between the data transceiver and the system bus and is connected directly to the CPU. When the CPU or the peripheral module satisfies a predetermined condition, the access controller accesses the location designated by the monitor address and transfers data between the external device and the designated location.

The predetermined condition may be, for example, the execution by the CPU of an instruction at a designated address, or the generation of an interrupt by the CPU or the peripheral module.

The predetermined condition may also include availability of the system bus, as indicated by a bus enable signal output by the CPU.

An external debugging device can accordingly monitor a designated location in the memory or the peripheral module and determine the contents of the designated memory location at a particular point in the program executed by the CPU, or when a particular event occurs and generates an interrupt. Debugging is facilitated because the debugging device can be sure of obtaining information relevant to the instruction or event, and no extra instructions need be embedded in the program to control the monitoring operation.

### BRIEF DESCRIPTION OF THE DRAWINGS

In the attached drawings:

FIG. 1 is a block diagram of a microcontroller according to a first embodiment of the invention;

FIG. 2 is a block diagram of a microcontroller according to a second embodiment; and

FIG. 3 is a block diagram of a conventional microcontroller.

### DETAILED DESCRIPTION OF THE INVENTION

Embodiments of the invention will now be described with reference to the attached drawings, in which like elements are indicated by like reference characters.

### First Embodiment

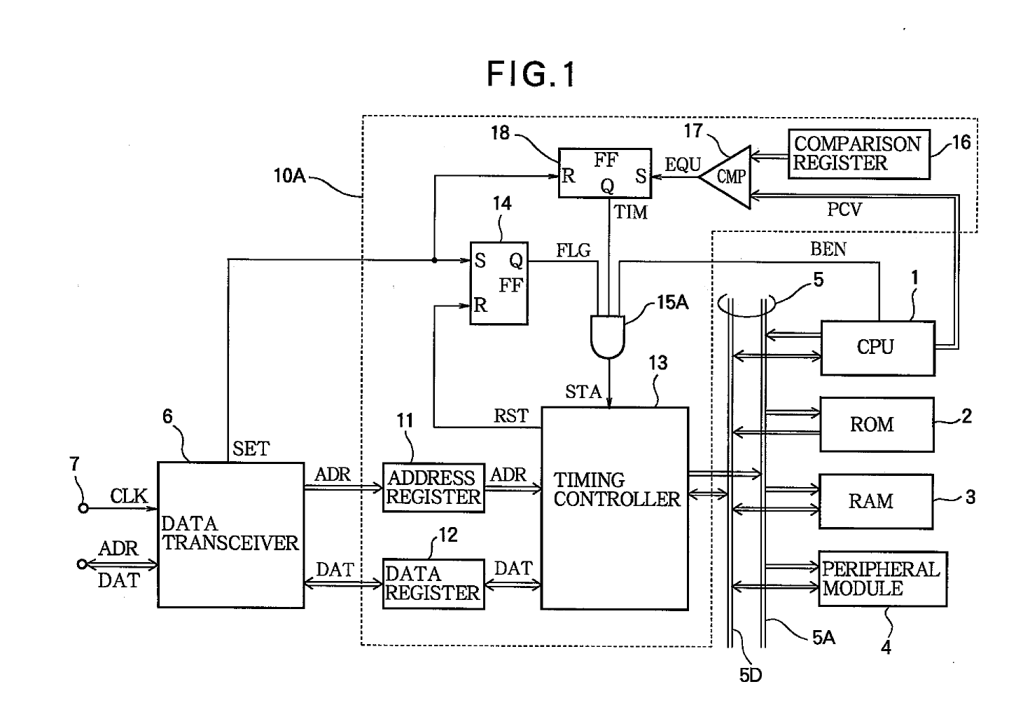

Referring to FIG. 1, the microcontroller in the first embodiment comprises a central processing unit (CPU) 1, a nonvolatile read-only memory (ROM) 2, a random access memory (RAM) 3, and at least one peripheral module 4. These facilities are linked to a system bus 5 comprising an address bus 5A and a data bus 5D.

The CPU 1 is a well-known circuit that executes a program stored in the ROM 2. The CPU 1 has a program counter (not shown) that indicates the address of the next instruction the CPU 1 will execute, so that the CPU 1 can fetch the instruction from the ROM 2 via the system bus 5. During program execution, the CPU 1 may also access the RAM 3 via the system bus 5, either to write data for temporary storage or to read data stored earlier. The CPU 1 outputs a bus enable signal (BEN) that is inactive (low) when the system bus 5 is in use and active (high) when the system bus 5 is not in use and is therefore available for RAM monitoring use.

The peripheral module 4 comprises specialized hardware for executing a specific function at the direction of the CPU 1. The peripheral module 4 has one or more internal registers, sometimes referred to as special function registers, for storing control data or other data related to the function performed by the peripheral module 4. These registers are designated by addresses on the address bus 5A and are accessed in substantially the same way as the RAM 3.

The microcontroller also includes a data transceiver 6 and an access controller 10A.

The data transceiver 6 has external terminals 7 for receiving a clock signal (CLK) and address signals (ADR) from an external device (not shown) and transferring data (DAT) between the external device and the access controller 10A in synchronization with the clock signal. In the following description the external device is a debugging device. Upon receiving address signals, the data transceiver 6 passes the address as a monitor address to the access controller 10A and generates a set signal.

The access controller 10A comprises an address register 11 that stores the monitor address received from the data transceiver 6, a data register 12 that stores data transferred to or from the data transceiver 6, and a timing controller 13 that receives the monitor address from the address register 11 and generates control signals. The control signals access the location designated by the monitor address by transferring data between the data register 12 and designated location via the system bus 5. The designated location may be a memory location in the RAM 3 or a register in the peripheral module 4, and may be a single-address location or a location spanning a range of addresses. When the timing controller 13 finishes accessing the designated location, it also asserts a reset (RST) signal.

The set signal generated by the data transceiver 6 and the reset signal generated by the timing controller 13 are received at the set terminal (S) and reset terminal (R) of a first flip-flop (FF) 14 in the access controller 10A. The first flip-flop 14 outputs a flag signal (FLG) from its output terminal (Q).

The access controller 10A also includes an AND gate 15A, a comparison register 16, a comparator 17 and a second flip-flop 18. The comparison register 16 stores an instruction address, which may be set by the external debugging device or by manual switches (not shown). The comparator 17 is connected to the comparison register 16 and the CPU 11 and compares the program counter value (PCV) in the CPU 1 with the instruction address stored in the comparison register 16. When the program counter value matches the stored instruction address, the comparator 17 generates an equality signal (EQU) that sets the second flip-flop 18. The second flip-flop 18 is reset by the set signal from the data transceiver 6, and generates a timing signal (TIM). The AND gate 15A receives the timing signal from the second flip-flop 18, the flag signal from the first flip-flop 14, and the bus enable signal from the CPU 1, and generates a start signal (STA) that activates the timing controller 13.

Next the debugging of the microcontroller in FIG. 1 will be described.

The debugging is typically carried out in-circuit, that is, with the microcontroller mounted in a circuit similar to the one in which it will actually be used. The debugging device is typically an engineering workstation connected to the external terminals 7 of the data transceiver 6 by a cable. In the debugging process, the CPU 1 executes the program stored in the ROM 2 under various conditions, and the debugging device observes the results produced.

During the debugging process, it is often useful to observe the contents of a particular RAM location or a particular peripheral module register at a particular point in program execution. Alternatively, it may be useful to intervene at a particular point in program execution by writing particular data in a particular RAM location or peripheral module register. In these cases, before program execution begins, an instruction address indicating the particular point in the program is set in the comparison register 16 by the debugging device or manually, and the address of the particular location or register is sent to the data transceiver 6 and set in the address register 11 as a monitor address. If write access to the monitor address is required, the data to be written are also sent to the data transceiver 6 and stored in the data register 12.

When the data transceiver 6 writes the monitor address in the address register 11, it drives the set signal to the high (‘1’) logic level. This action sets the first flip-flop 14 and resets the second flip-flop 18, so that the flag signal (FLG) is high (‘1’) and the timing signal (TIM) is low (‘0’). Since the timing signal is low, the start signal (STA) output by the AND gate 15A is also low, despite the active flag signal (FLG) and regardless of the state of the bus enable signal (BEN). The low start signal (STA) holds the timing controller 13 in the inactive state.

The CPU 1 then executes its program until the program counter value (PCV) matches the instruction address stored in the comparison register 16. At that point the equality signal (EQU) output by the comparator 17 goes high, setting the second flip-flop 18, so the timing signal (TIM) goes high.

If the system bus 5 is not in use at this instant and is available for use by the access controller 10A, the bus enable signal BEN will also be high. Accordingly, all inputs to the AND gate 15A will be high, so the start signal (STA) will go high, activating the timing controller 13. The timing controller 13 then places the monitor address on the address bus 5A and generates control signals that transfer the data stored at the location designated by the monitor address into the data register 12 (read access) or transfer the data stored in the data register 12 to the designated location (write access).

If the CPU 1, peripheral module 4, or another peripheral module (not shown) is using the system bus 5 when the timing signal goes high, so that the bus enable signal (BEN) is low, the start signal remains low until the CPU 1 or peripheral module relinquishes the bus, at which point the bus enable signal goes high. When the bus enable signal goes high, the start signal also goes high, and the timing controller 13 accesses the monitor address location.

In either case, as soon as the timing controller 13 has finished transferring data to or from the monitor address location, it asserts the reset signal (RST), thereby forcing the flag signal (FLG) to the low logic level. The start signal (STA) then goes low and the timing controller 13 is deactivated. In the read access case, the external device can now read the data obtained by the timing controller 13 from the data register 12 while the CPU 1 continues to execute the program stored in the ROM 2.

The first embodiment enables the debugging device to access a designated RAM location or peripheral module register at a known point in program execution, either at the execution of a known instruction or at the first opportunity after the execution of the known instruction. A person skilled in the debugging art will realize that there are many ways in which this feature can be used.

In a variation of the first embodiment, the timing controller 13 is used only for read access to the location designated by the monitor address.

In another variation, the comparator 17 obtains the program counter value from the value placed by the CPU 1 on the address bus 5A, instead of receiving it directly from the CPU 1.

### Second Embodiment

The second embodiment modifies the access controller so that monitor access is responsive to an interrupt instead of to the program counter value.

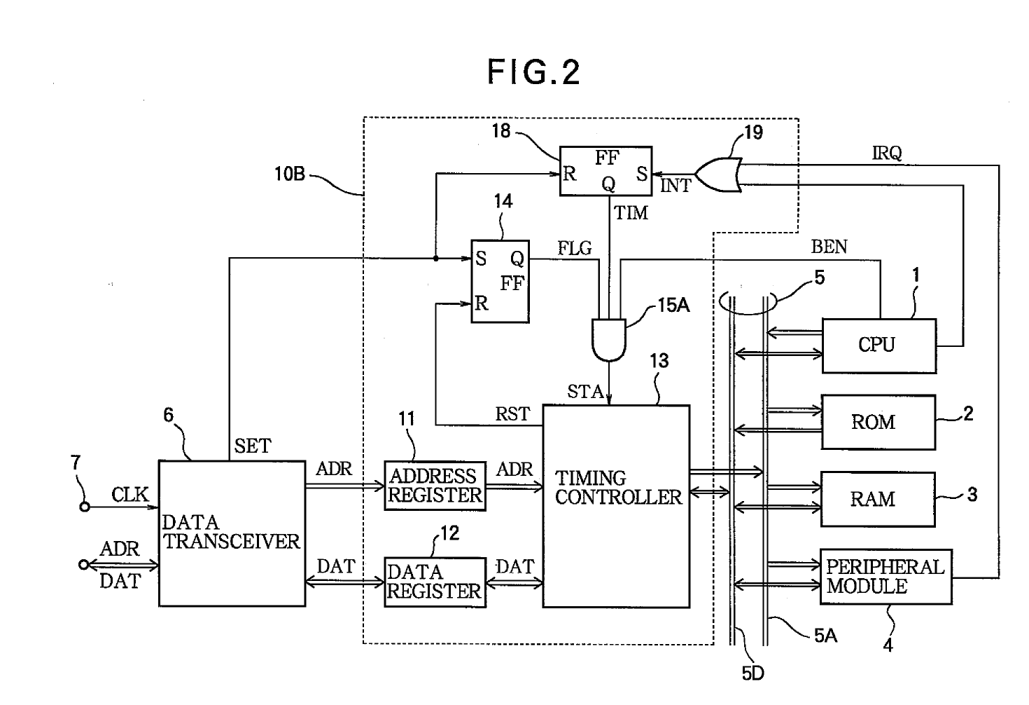

Referring to FIG. 2, the access controller 10B in the second embodiment includes an OR gate 19 in place of the comparison register and comparator of the first embodiment. The OR gate 19 receives an interrupt request (IRQ) signal from the peripheral module 4 and an interrupt signal from the CPU 1, and outputs an interrupt signal (INT) to the set terminal (S) of the second flip-flop 18. Other parts of the microcontroller in FIG. 2 are identical to the corresponding parts of the microcontroller in the first embodiment (FIG. 1).

For the debugging process in the second embodiment, it is not necessary to set an instruction address before program instruction begins. The debugging device only has to transfer a monitor address to the data transceiver 6, which sets the monitor address in the address register 11. As in the first embodiment, this activates the set signal, setting the first flip-flop 14 and resetting the second flip-flop 18, so that the start signal (STA) output by the AND gate 15A is low and the timing controller 13 is held in the inactive sate.

During program execution, the timing controller 13 remains inactive until the CPU 1 or peripheral module 4 generates an interrupt. An interrupt generated by the peripheral module 4 typically indicates the completion of a timing interval or a specialized hardware operation. An interrupt generated by the CPU 1 typically indicates a program exception such as an undefined instruction or some other type of error. When an interrupt occurs, one of the signals received by the OR gate 19 goes high, causing the interrupt signal output by the OR gate 19 to go high, setting the second flip-flop 18. The timing signal (TIM) consequently goes high.

When the timing signal goes high, the start signal output by the timing controller 13 goes high, either immediately or as soon as the system bus 5 becomes available, as explained in the first embodiment. The high start signal activates the timing controller 13, which accesses the memory location or peripheral module register designated by the monitor address. Upon completion of access, the timing controller 13 asserts the reset signal (RST), resetting the first flip-flop 14 so that the flag signal (FLG) and start signal (STA) return to the low logic level, deactivating the timing controller 13.

The second embodiment enables the debugging device to access a designated memory location or peripheral module register when a particular event occurs, as indicated by an interrupt. This provides a useful way to monitor circumstances surrounding events that are not synchronized with the execution of a particular instruction but might occur at any point in program execution.

The variations of the first embodiment noted above also apply to the second embodiment.

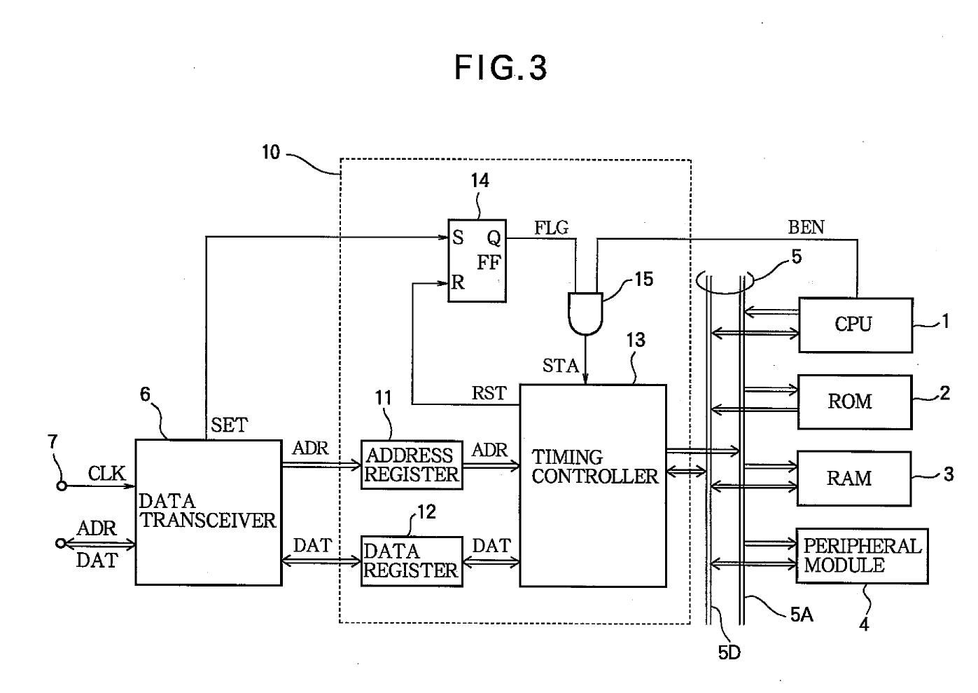

For comparison with the preceding embodiments, FIG. 3 shows a conventional microcontroller generally similar to the microcontrollers in FIGS. 1 and 2 but lacking the comparison register and comparator of the first embodiment and the OR gate of the second embodiment. Accordingly, the AND gate 15 in the access controller 10 receives only the flag signal (FLG) from the first flip-flop 14 and the bus enable signal (BEN) from the CPU 1.

In this conventional microcontroller, the debugging device can monitor arbitrary memory locations and peripheral module registers by sending their addresses to the data transceiver 6 to be written in the address register 11 of the access controller 10, but the access controller 10 cannot accurately synchronize its monitoring activities with the execution of particular instructions by the CPU 1 or the occurrence of particular interrupt-generating events. The information obtained by monitoring is therefore not as useful as the information obtainable in the first and second embodiments.

A few variations of the preceding embodiments have already been mentioned, but those skilled in the art will recognize that further variations are possible within the scope of the invention, which is defined in the appended claims.

What is claimed is:

1. A microcontroller having a central processing unit, a memory, and at least one peripheral module interconnected by a system bus, the microcontroller comprising:
a data transceiver for receiving a monitor address from an external device, the monitor address designating a location in the memory or a location in the peripheral module; and
an access controller interposed between the data transceiver and the system bus and connected directly to the central processing unit, for accessing the location designated by the monitor address when the central processing unit or the peripheral module satisfies a predetermined condition and transferring data between the external device and the designated location.

2. The microcontroller of claim 1, wherein the central processing unit has a program counter, and the predetermined condition includes the presence of a specific value in the program counter.

3. The microcontroller of claim 2, wherein the access controller comprises:
a comparison register for storing an instruction address; and
a comparator for comparing the instruction address stored in the comparison register with a value stored in the program counter in the central processing unit.

4. The microcontroller of claim 2, wherein the central processing unit generates a bus enable signal indicating availability of the system bus, and the predetermined condition also includes the availability of the system bus.

5. The microcontroller of claim 4, wherein the access controller comprises:
a comparison register for storing an instruction address; and
a comparator for comparing the instruction address stored in the comparison register with a value stored in the program counter in the central processing unit;
an address register for storing the monitor address;
a data register for storing the data transferred between the external device and the designated location;
a timing controller for generating control signals controlling access to the designated location;
a first flip-flop connected to the data transceiver and the timing controller, for generating a flag signal that is set when the data transceiver sets the monitor address in the address register and is reset when the timing controller accesses the designated location;
a second flip-flop connected to the data transceiver and the comparator, for generating a timing signal that is reset when the data transceiver sets the monitor address in the address register and is set when the value in the program counter matches the instruction address stored in the comparison register; and
a logic gate receiving the flag signal, the timing signal, and the bus enable signal and generating a start signal that activates the timing controller.

6. A method of debugging the microcontroller of claim 5, comprising:
setting the instruction address in the comparison register;
setting the monitor address in the address register;
comparing the value in the program counter with the instruction address; and
accessing the location designated by the monitor address when the value in the program counter matches the instruction address.

7. The microcontroller of claim 1, wherein at least one of the central processing unit and the peripheral module generates an interrupt, and the predetermined condition includes generation of the interrupt.

8. The microcontroller of claim 7, wherein the central processing unit generates a bus enable signal indicating availability of the system bus, and the predetermined condition also includes the availability of the system bus.

9. The microcontroller of claim 8, wherein the access controller comprises:
an address register for storing the monitor address;
a data register for storing the data transferred between the external device and the designated location;
a timing controller for generating control signals controlling access to the designated location;
a first flip-flop connected to the data transceiver and the timing controller, for generating a flag signal that is set when the data transceiver sets the monitor address in the address register and is reset when the timing controller accesses the designated location;
a second flip-flop connected to the data transceiver, for generating a timing signal that is reset when the data transceiver sets the monitor address in the address register and is set when the interrupt is generated; and
a first logic gate receiving the flag signal, the timing signal, and the bus enable signal and generating a start signal that activates the timing controller.

10. The microcontroller of claim 9, wherein both the central processing unit and the peripheral module generate respective interrupt signals, and the access controller further comprises:
a second logic gate connected to the second flip-flop, for receiving the interrupt signals from the central processing unit and the peripheral module and generating a signal that sets the timing signal.

11. A method of debugging the microcontroller of claim 9, comprising:
setting the monitor address in the address register;
monitoring the central processing unit or the peripheral module; and
accessing the location designated by the monitor address when the central processing unit or the peripheral module generates an interrupt.
